(19) United States
(12) Patent Application Publication
(10) Pub. No.: US 2014/0089477 A1
(43) Pub. Date: Mar. 27, 2014

(54) SYSTEM AND METHOD FOR MONITORING STORAGE MACHINES

(71) Applicants: Hon Hai Precision Industry Co., Ltd., New Taipei (TW); Hong Fu Jin Precision Industry (ShenZhen) CO., LTD., Shenzhen (CN)

(72) Inventors: HAO ZHOU, Shenzhen (CN); BIN ZHENG, Shenzhen (CN); CHUNG-I LEE, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/950,656

(22) Filed: Jul. 25, 2013

(30) Foreign Application Priority Data
Sep. 27, 2012 (CN) 201210369586X

(51) Int. Cl. H04L 12/26

(52) U.S. Cl. CPC H04L 43/04
USPC 709/222; 709/224

(57) ABSTRACT

For a data processing device, a method for monitoring aspects of storage machines in a cloud storage system is computerized and maintained in a non-transitory storage medium. Resource usages of a storage machine are checked periodically, and it is determined that whether the resource usages of the storage machine are greater than predetermined thresholds. When all the resource usages are greater than the predetermined thresholds, it is recorded that a test for the storage machine is not executed, and when any of the resource usages is less than a corresponding threshold, performances of the storage machine are tested to obtain performance parameters. The test is recorded into the testing log, then the testing log is sent to a host server in the cloud storage system.

### BACKGROUND

1. Technical Field

Embodiments of the present disclosure relate to cloud storage, and more particularly to a system and a method for monitoring storage machines in a cloud storage system.

2. Description of Related Art

Cloud storage is a service model in which data is maintained, managed and backed up in storage machines of a remote cloud storage system and made available to users over a network (typically the Internet).

Stability of the cloud storage system is mainly based on performances of the storage machines. Thus, it is important to monitor the storage machines in the cloud storage system.

### BRIEF DESCRIPTION OF THE DRAWINGS

FIG. 1 is a block diagram of one embodiment of a cloud storage system.

FIG. 2 is a block diagram of one embodiment of a virtual machine created in a storage machine in the cloud storage system in FIG. 1.

FIG. 3 illustrates a flowchart of one embodiment of a method for monitoring storage machines in the cloud storage system in FIG. 1.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device.

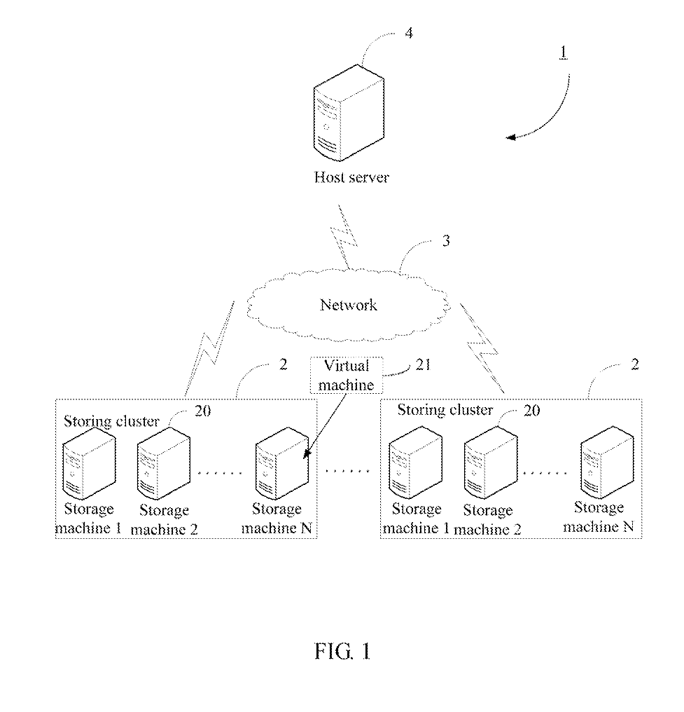

FIG. 1 is a block diagram of one embodiment of a cloud storage system. The cloud storage system 1 includes a plurality of storage machines 20 and a host server 4. The storage machines 20 communicate with the host server 4 through a network 3. The network 3 may be the Internet or an intranet.

The storage machines 20 may include some type(s) of computer-readable non-transitory storage medium, such as a hard disk drive, a compact disc, a digital video disc, a tape drive, or a storage server. The storage machines 20 are divided into one or more storing clusters 2 according to locations of the storage machines or a predetermined dividing rule. Thus, each storing cluster 2 includes one or more storage machines 20.

Each of the storage machines 20 has one or more performance test tools, such as IOMeter or IOZone installed. IOMeter is an I/O subsystem measurement and characterization tool for single and clustered systems, and is used as a benchmark and troubleshooting tool and is easily configured to replicate the behaviours of many popular applications. IOZone is a filesystem benchmark tool, which generates and measures a variety of file operations.

In each of the storing clusters 2, a virtual machine (VM) 21 is created and runs in one storage machine 20. The VM 21 can be considered as a data processing device. In one embodiment, the VM 21 is created in the storage machine 20 which has the lowest resource usages in the storing cluster 2. The resource usages include, for example, a CPU utilization, a memory utilization, and a disk queue length.

In another embodiment, the VM 21 can also be created to run in a single server and not in the storage machine 20 of the storing cluster 2.

The host server 4 obtains testing logs of the storage machines 20 from the VM 21 in each of the storing clusters 2, analyzes and integrates the testing logs, to evaluate performances of the storage machines 20.

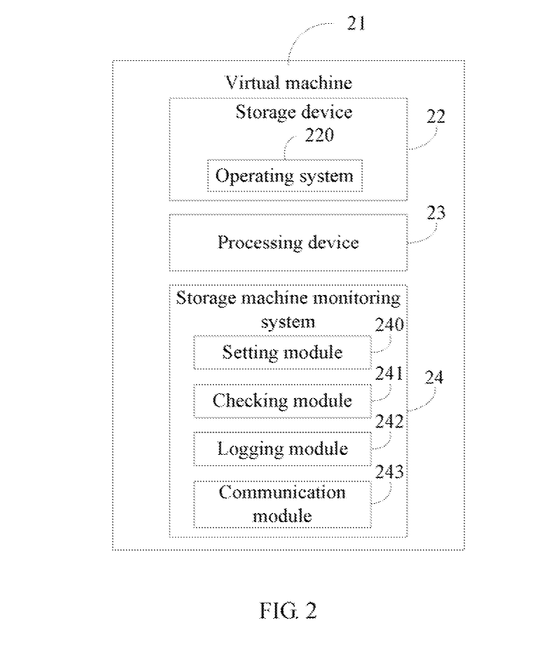

FIG. 2 is a block diagram of one embodiment of the VM 21. The VM 21 includes a storage device 22, a processing device 23, and a storage machines monitoring system 24.

The storage device 22 is a memory space in the storage machine 20 which runs the VM 21. The storage device 22 stores an operating system 220 of the VM 21. The processing device 23 is a processor (not shown) of the storage machine 20 which runs the VM 21.

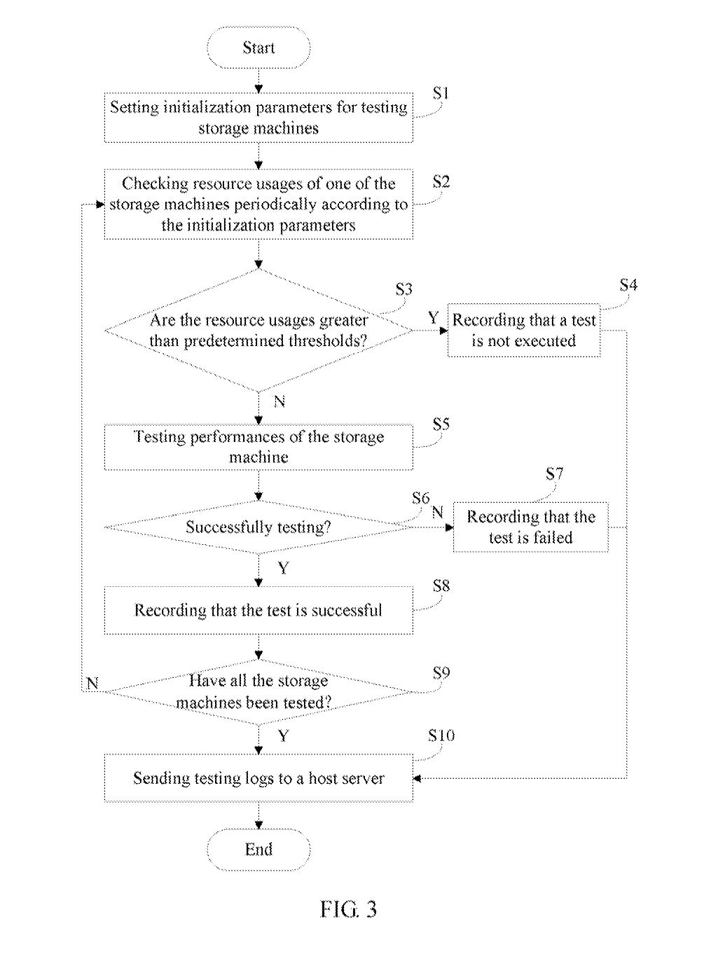

The storage machines monitoring system 24 includes a number of function modules, such as a setting module 240 a checking module 241, a logging module 242, and a communication module 243. The function modules 240-243 may include computerized codes in the form of one or more programs stored in the storage device 22, which can be executed by the processing device 23 to perform at least the functions needed to execute the steps illustrated in FIG. 3.

FIG. 3 illustrates a flowchart of one embodiment of a method for monitoring storage machines 20 in the cloud storage system 1. Depending on the embodiment, additional steps in FIG. 3 may be added, others removed, and the ordering of the steps may be changed.

In step S1, the setting module 240 sets initialization parameters for testing the storage machines 20 in each storage cluster 2. In one embodiment, the initialization parameters include machine names, testing intervals, testing authorities, and other relevant information. The machine names indicate which of the storage machines 20 need to be tested. The testing authorities include user names and passwords.

In step S2, the checking module 241 checks resource usages of one of the storage machines 20 periodically according to the initialization parameters. As mentioned, the resource usages include, for example, a CPU utilization, a memory utilization, and a disk queue length.

In step S3, the checking module 241 determines whether the resource usages of the storage machine 20 are greater than predetermined thresholds. In one embodiment, a threshold of the CPU utilization is 60%, a threshold of the memory utilization is 50%, and a threshold of the disk queue length is 20. When the resource usages of the storage machine 20 are greater than the corresponding thresholds, it indicates that the storage machine 20 is busy, and step S4 is implemented. When any the resource usages of the storage machine 20 is less than the corresponding threshold, it indicates that the storage machine 20 is substantially free, and then step S5 is implemented.

In step S4, the logging module 242 records that a test is not executed into a testing log. In one embodiment, the testing log includes data such as a date, a machine name, and a message “cannot execute test.”

In step S5, the checking module 241 tests performances of the storage machine 20 using the performance test tools, such as IOMeter or IOZone.

In step S6, the checking module 241 determines if the test for the storage machine 20 successful. When the checking module 241 does not obtain any performance parameters of the storage machine 20, the checking module 241 determines that the test for the storage machine 20 failed, and step S7 is implemented. Otherwise, when checking module 241 obtains at least one performance parameter of the storage machine 20, the checking module 241 determines that the test for the storage machine 20 successful, and step S8 is implemented.

In step S7, the logging module 242 records that the test failed into the testing log. In one embodiment, the testing log includes data such as, a date, a machine name, a test type, and a message “execute abort.”

In step S8, the logging module 242 records that the test successful into the testing log. In one embodiment, the testing log includes data such as, a date, a machine name, a test type, and a Key Performance Indicator (KPI) value. The KPI value includes an Input/Output Operations Per Second (IOPs) value or any other performance parameter.

In step S9, the checking module 241 determines whether all the storage machines 20 have been tested. When any storage machine 20 has not been tested, the process goes back to step S2. Otherwise, when all the storage machines 20 have been tested, step S10 is implemented.

In step S10, the communication module 243 sends the testing logs to the host server 4. The host server 4 analyzes and integrates the testing logs to evaluate respective performances of the storage machines 20.

It should be emphasized that the above-described embodiments of the present disclosure, including any particular embodiments, are merely possible examples of implementations, set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

What is claimed is:

1. A method for monitoring storage machines in a cloud storage system, the method comprising:
checking resource usages of a storage machine periodically;
determining whether the resource usages of the storage machine are greater than predetermined thresholds;
recording that a test for the storage machine is not executed into a testing log when all the resource usages are greater than the predetermined thresholds;
testing performances of the storage machine to obtain performance parameters of the storage machine when any of the resource usages is less than a corresponding threshold;
recording that the test failed into the testing log when any performance parameter of the storage machine is not obtained;
recording that the test successful into the testing log when at least one performance parameter of the storage machine is obtained; and
sending the testing log to a host server in the cloud storage system.

2. The method according to claim 1, wherein the method further comprises:
setting initialization parameters for testing the storage machines, wherein the initialization parameters comprises machine names, testing intervals, and testing authorities.

3. The method according to claim 1, wherein the resource usages comprises a CPU utilization, a memory utilization, and a disk queue length.

4. The method according to claim 3, wherein the threshold of the CPU utilization is 60%, the threshold of the memory utilization is 50%, and the threshold of the disk queue length is 20.

5. The method according to claim 1, wherein the storage machines are divided into one or more storing clusters according to locations of the storage machines or a predetermined dividing rule.

6. The method according to claim 5, wherein the method is implemented in a virtual machine (VM) which is created and running in each of the storing clusters.

7. A data processing device, comprising:
a processing device; and
a storage device storing one or more programs which when executed by the processing device, causes the processing device to:
check resource usages of a storage machine periodically;
determine whether the resource usages of the storage machine are greater than predetermined thresholds;
record that a test for the storage machine is not executed into a testing log when all the resource usages are greater than the predetermined thresholds;
test performances of the storage machine to obtain performance parameter of the storage machine when any of the resource usages is less than a corresponding threshold;
record that the test failed into the testing log when any performance parameter of the storage machine is not obtained;
record that the test successful into the testing log when at least one performance parameter of the storage machine is obtained; and
send the testing log to a host server in a cloud storage system.

8. The data processing device according to claim 7, wherein the one or more programs further cause the processing device to:
set initialization parameters for testing one or more storage machines, wherein the initialization parameters comprises machine names, testing intervals, testing authorities.

9. The data processing device according to claim 1, wherein the resource usages comprises a CPU utilization, a memory utilization, and a disk queue length.

10. The data processing device according to claim 3, wherein the threshold of the CPU utilization is 60%, the threshold of the memory utilization is 50%, and the threshold of the disk queue length is 20.

11. The data processing device according to claim 7, wherein the storage machines are divided into one or more storing clusters according to locations of the storage machines or a predetermined dividing rule.

12. The data processing device according to claim 11, wherein the data processing device is a virtual machine (VM) which is created and running in each of the storing clusters.

13. A non-transitory storage medium having stored thereon instructions that, when executed by a processor of a data processing device, causes the processor to perform a method for monitoring storage machines in a cloud storage system, wherein the method comprises:
checking resource usages of a storage machine periodically;
determining that whether the resource usages of the storage machine are greater than predetermined thresholds; (comments: what is corresponding? It is indefinite)
recording that a test for the storage machine is not executed into a testing log when all the resource usages are greater than the predetermined thresholds;
testing performances of the storage machine to obtain performance parameters of the storage machine when any of the resource usages is less than a corresponding threshold;
recording that the test failed into the testing log when any performance parameter of the storage machine is not obtained;
recording that the test successful into the testing log when at least one performance parameter of the storage machine is obtained; and
sending the testing log to a host server in the cloud storage system.

14. The non-transitory storage medium according to claim 13, wherein the method further comprises:
setting initialization parameters for testing the storage machines, wherein the initialization parameters comprises machine names, testing intervals, and testing authorities.

15. The non-transitory storage medium according to claim 13, wherein the resource usages comprises a CPU utilization, a memory utilization, and a disk queue length.

16. The non-transitory storage medium according to claim 15, wherein the threshold of the CPU utilization is 60%, the threshold of the memory utilization is 50%, and the threshold of the disk queue length is 20.

17. The non-transitory storage medium according to claim 13, wherein the storage machines are divided into one or more storing clusters according to locations of the storage machines or a predetermined dividing rule.

18. The non-transitory storage medium according to claim 17, wherein the method is implemented in a virtual machine (VM) which is created and running in each of the storing clusters.
